(19) United States
(12) Patent Application Publication
(10) Pub. No.: US 2015/0071456 A1
(43) Pub. Date: Mar. 12, 2015

(54) SYSTEM AND METHOD FOR ILLUMINATING A HEADPHONE TO INDICATE VOLUME AND/OR BEAT

(71) Applicant: Shane Cameron Steenkamp, Draper, UT (US)

(72) Inventor: Shane Cameron Steenkamp, Draper, UT (US)

(21) Appl. No.: 14/020,817

(22) Filed: Sep. 7, 2013

(51) Int. Cl. H04R 1/10

(52) U.S. Cl. CPC H04R 1/1041
USPC 381/74

(57) ABSTRACT

A system, apparatus and method for illuminating a headphone to indicate the volume and/or rhythm of an audio signal emitting from the headphone through a flashing illuminated pattern of light emitting diodes visible to an observer. The pattern and synchronization of the illumination pattern provides an instantaneous, graphical indication of the volume, rhythm, intensity, and frequency of the audio signal. The invention includes a headphone. A plurality of light emitting diodes (LEDs) operably attach to the headphone(s). The LEDs form a pattern in, or on, the headphone(s) that is efficacious for prominently displaying the illumination. Various pattern shapes can be utilized. The illumination produced by the LEDs is efficacious for signaling the different variances of the audio signal. A USB cable may provides power and data signals for the headphone(s). A battery may provide power. A heat sink helps dissipate heat from the LEDs.

### FIELD OF THE INVENTION

This invention relates to headphones, and more particularly relates to a method and system for illuminating a headphone as a function of a volume and a rhythm for an audio signal.

### BACKGROUND

### Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

By way of educational background, another aspect of the prior art generally useful to be aware of is that headphones may include a pair of small loudspeakers that are designed to be held in place close to a user's ears. Headphones either have wires for connection to a signal source such as an audio amplifier, radio, CD player, portable media player or mobile phone, or have a wireless receiver, which is used to pick up signal without using a cable.

Typically, volume is referred to as the loudness of the sound. Sound is a mechanical wave that is an oscillation of pressure transmitted through some medium such as air or water, composed of frequencies within the range of hearing. Sound that is perceptible by humans has frequencies from about 20 Hz to 20,000 Hz.

Often, third-party observers cannot determine if a user wearing a headset is listening to an audio signal or if the headset is silent. This is because the sound emitting from the headphones is indiscernible by the observer. Consequently, it is often difficult to determine if the user can hear any external noises, comments or questions.

In many instances, light emitting diodes (LEDs) may be utilized to signal an event. LEDs offer very long service life, extreme vibration resistance, and can permit considerably shallower packaging compared to most bulb-type assemblies.

In view of the foregoing, it is clear that these traditional headphone illuminating systems and methods are not perfect and leave room for more optimal approaches.

### SUMMARY

From the foregoing discussion, it should be apparent that a need exists for a system and method for illuminating a headphone with a pattern of flashing light emitting diodes that indicate the volume and rhythm of an audio signal. Beneficially, such a system and method would provide a plurality of features and components efficacious for indicating to a user and an observer the status of an audio signal, including, power, volume, rhythm, and intensity.

The present invention has been developed in response to the present state of the art, and in particular, in response to the problems and needs in the art that have not yet been fully solved by currently available products. Accordingly, the present invention has been developed to provide a system and method for illuminating a headphone with light emitting diodes as a function of volume and rhythm to indicate the status of an audio signal emitting from a headphone that overcomes many or all of the above-discussed shortcomings in the art.

In one embodiment of the present invention, the system for illuminating a headphone is configured to indicate the volume and rhythm of an audio signal emitting from a headphone through a flashing illumination pattern of light emitting diodes. The pattern and synchronization of the illumination pattern provides an instantaneous, graphical indication of the status of the audio signal. In some embodiments, the system comprises at least one headphone, including, without limitation, ear buds, a headset, and an in-ear monitor configured to output an audio signal. A plurality of light emitting diodes (LEDs) may be operably attachable to an external or internal surface of the at least one headphone. In some embodiments, the LEDs may detach from the at least one headphone. In this manner, the color of the illumination may be interchanged, and damaged LEDs may be replaced. In some embodiments, the LEDs form a pattern in the at least one headphone that is efficacious for prominently displaying the illumination. The illumination produced by the LEDs is efficacious for signaling the different variances of the audio signal. Those skilled in the art, in light of the present teachings, will recognize LEDs present many advantages over incandescent light sources including, without limitation, lower energy consumption, longer lifetime, improved physical robustness, smaller size, and faster switching.

In one embodiment of the present invention, the LEDs are configured to operate as a function of a volume and a rhythm of the audio signal, wherein the intensity and frequency of the LEDs is variable. The LEDs may also vary in conjunction with intensity and a frequency of the audio signal. In this manner, the volume and intensity of the audio signal is visually indicated on the at least one headphone. For example, without limitation, the LEDs may flash in accordance with a musical beat of the audio signal. In some embodiments, the configuration and shape of the LEDs on the at least one headphone forms an illumination pattern. The illumination pattern may form, in essence, a volume meter that is visible to a third-party observer. The LEDs forming the volume may be affixed exteriorly to the headset, or in the preferred embodiment, recessed into the headset and visible through a transparent polymeric bubble or convexly-shaped piece of glass overlaying the LEDs and forming part of the external housing of at least one headset. The illumination pattern may include various shapes and configurations, including, without limitation, a series of dashed lines, semi-circular, straight line, V-shaped, square, pyramid, diagonal line, text, and a graphical depiction. In yet another embodiment, a secondary illumination pattern may display on the at least one headphone to indicate a bass and a treble of the audio signal.

In one embodiment of the present invention, a controller regulates the audio signal, and related functions of the system. The controller may operate remotely. In some embodiments, a USB cable is configured to transmit signals and/or power to the system. In this manner, the system may join with portable electronic devices, including, without limitation, cellular telephones, personal digital assistants, portable music players, and computers. In some embodiments, The LEDs generate a considerable amount of heat within the housing. A heat sink may be efficacious for dissipating the heat generated by the LEDs.

A method of the present invention is also presented for illuminating the headphones. The method may include an initial Step of adorning the at least one headphone. The at least one headphone is configured to be operable to position on the head, whereby onlookers may observe the status of the audio signal being played in the at least one headphone.

In some embodiments, a next Step 604 includes actuating an audio signal with the controller. The controller may control various functions, including, without limitation, power, volume, balance, bass, and treble. The controller may also regulate the intensity of the illumination.

A next Step may include illuminating the LEDs. Those skilled in the art, in light of the present teachings, will recognize that the LEDs utilize electroluminescence to generate light. When LEDs power on, electrons recombine with holes within the LEDs, releasing energy in the form of photons. This effect is called electroluminescence and the color of the light, corresponding to the energy of the photon, is determined by the energy band gap of the semiconductor.

The method may then proceed to a Step of forming an illumination pattern as a function of a volume and a rhythm of the audio signal. The illumination pattern may comprise predetermined spaces where the LEDs position. The synchronization of the LEDs in the predetermined spaces forms a volume meter.

A final Step includes varying the illumination pattern as a function of an intensity and frequency of the audio signal. The intensity and frequency of the audio signal may also dictate the illumination pattern. The type of audio signal may be indicated in this manner. For example, music playing over the headphones may be indicated by short, blinking illumination, while a talk show or speech patterns may be displayed with longer durations of illumination of the LEDs.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating an illuminating headphone system in operation on a user, in accordance with the present invention;

FIG. 2 is a perspective view illustrating an illuminating headphone, with individual light emitting diodes, and a controller, in accordance with the present invention;

FIG. 3 is a perspective view illustrating an illuminating headphone, with a predetermined pattern of light emitting diodes, in accordance with the present invention;

FIG. 4 is a perspective view illustrating illuminating ear buds, with individual light emitting diodes, and a controller, in accordance with the present invention;

FIGS. 5A, 5B, 5C, and 5D are top views illustrating various illumination patterns, where FIG. 5A is a line pattern of light emitting diodes, FIG. 5B is a line pattern of illuminating light emitting diodes, FIG. 5C is an arrow shaped pattern of light emitting diodes, and FIG. 5D is an arrow shaped pattern of illuminating light emitting diodes, in accordance with the present invention; and

FIG. 6 is a process flow chart of a method for illuminating a headphone, in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

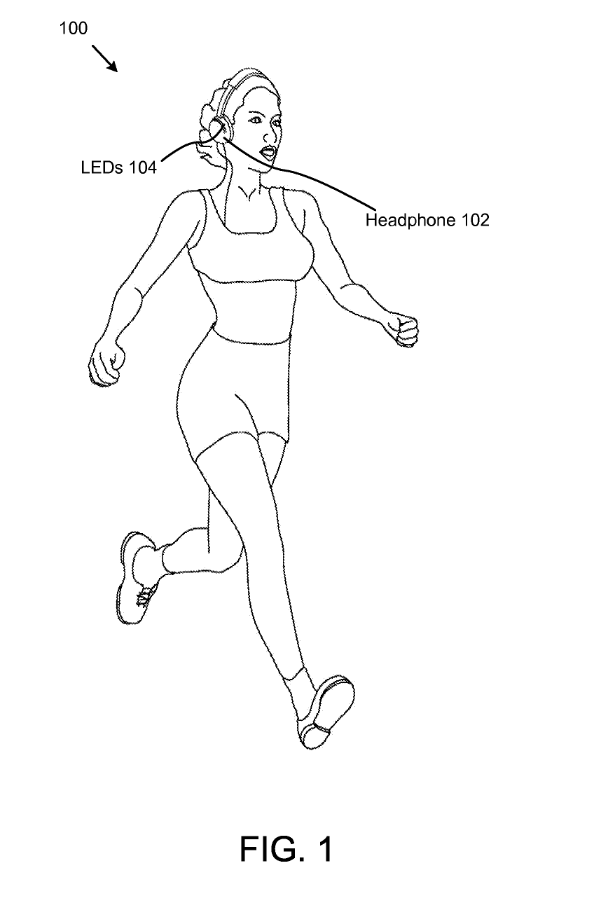

FIGS. 1-5 depict a system 100 for illuminating a headphone as a function of a volume and a rhythm through the illumination of a plurality of light emitting diodes 104 (LEDs). The system 100 is configured to display the volume and rhythm of an audio signal emitting from at least one headphone 102 through a flashing pattern of LEDs 104. The system 100 comprises at least one headphone 102, including, without limitation, ear buds, a headset, and an in-ear monitor configured to output the audio signal. Those skilled in the art will recognize that the at least one headphone 102 may include a pair of small loudspeakers configured to be held in place close to a user's ears. The at least one headphone 102 either has wires for connection to a signal source such as an audio amplifier, radio, CD player, portable media player or mobile phone, or have a wireless receiver, which is used to pick up signal without using a wiring system (FIG. 1).

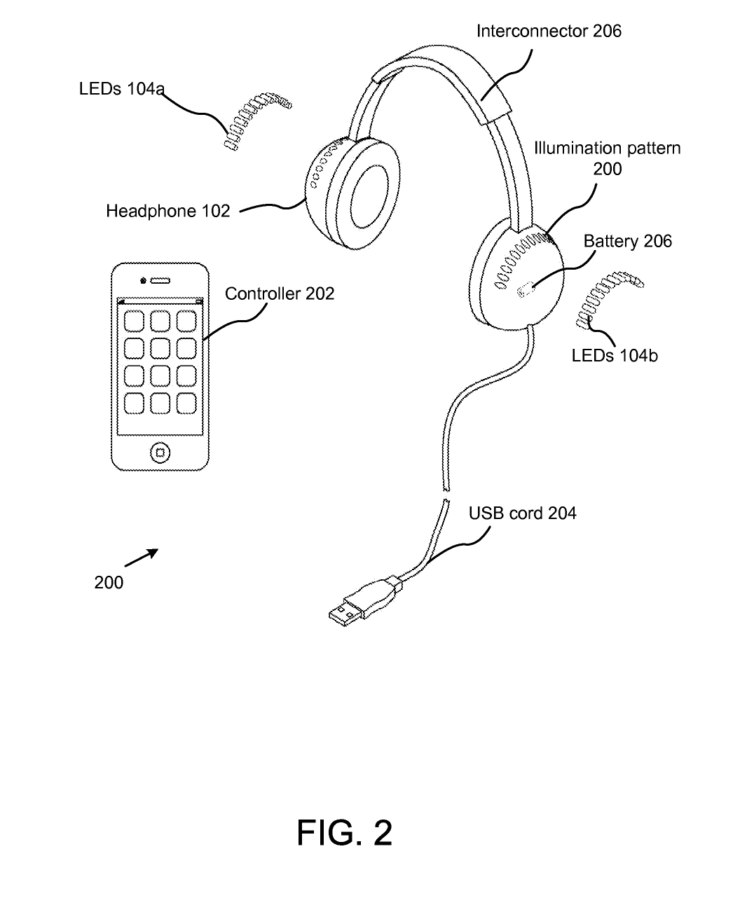

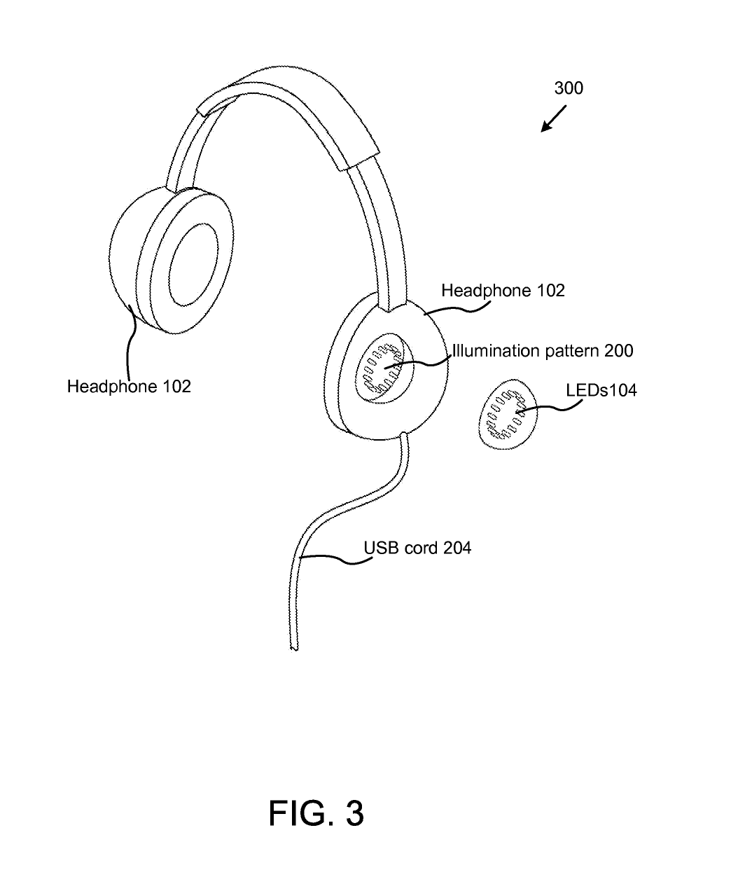

In one embodiment, the at least one headphone 102 comprises a pattern and synchronization of LEDs 104 that form an illumination pattern 200. The illumination pattern 200 is efficacious for providing an instantaneous, graphical indication of the status of the audio signal. The LEDs 104 operably attach to an external surface of the at least one headphone 102. In some embodiments, the LEDs 104 may detach from the at least one headphone 102. In this manner, the color of the illumination may be interchanged. In some embodiments, the LEDs 104 form an illumination pattern 200 in the at least one headphone 102 that is efficacious for prominently displaying the variances of the audio signal. Those skilled in the art, in light of the present teachings, will recognize that the LEDs 104 comprise of solid state light sources having a long life, and generating an intense source of illumination. LEDs 104 present many advantages over incandescent light sources including, without limitation, lower energy consumption, longer lifetime, improved physical robustness, smaller size, and faster switching. The LEDs 104 may detach separately from the at least one headphone 102, as referenced in FIG. 2, or as a complete set, as referenced in FIG. 3.

The LEDs may partially circumscribe the perimeter of the headphones. The LEDs may be configured to change illumination color in response to audio signals exceeding a predetermined threshold such as 70, 75, 80, 85, 90, 95, 100, 105, 110, 115 or 120 decibels. In various embodiments, the LEDs vary in size and/or luminescence across the illumination pattern.

In various embodiments, each LED is recessed separately from one another into a shell or outer housing of the headphone(s). The LEDs may collectively be recessed into a single concave opening in the shell or outer housing; and, in some embodiments, that opening may be covered by a transparent or semi-transparent glass or polymeric material.

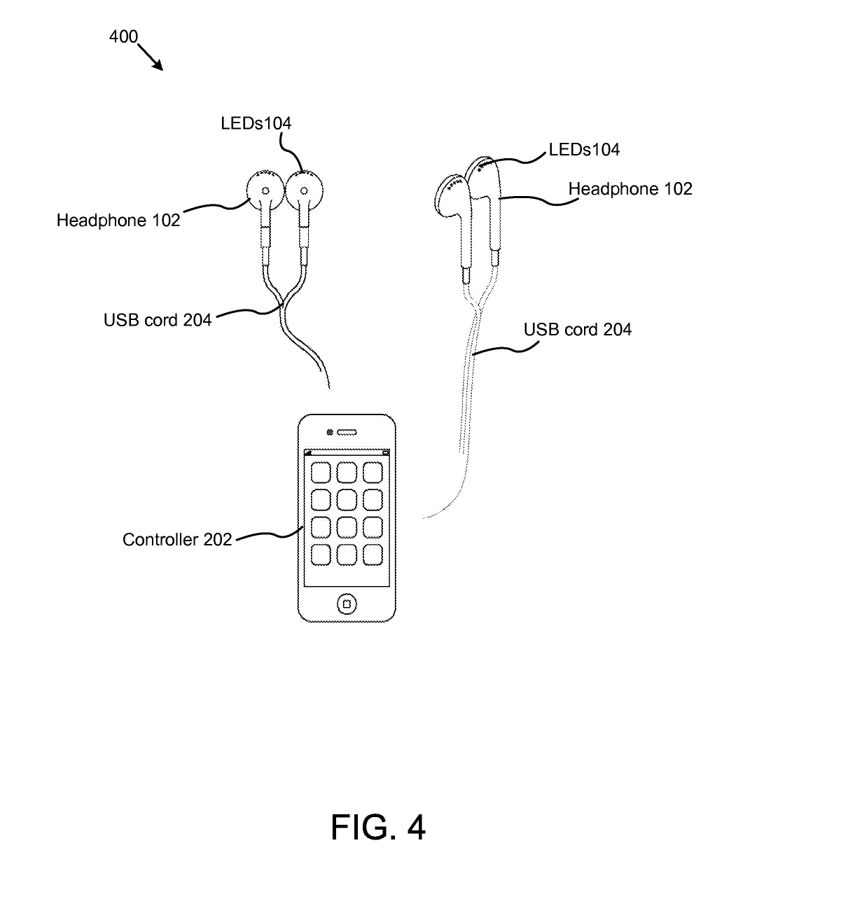

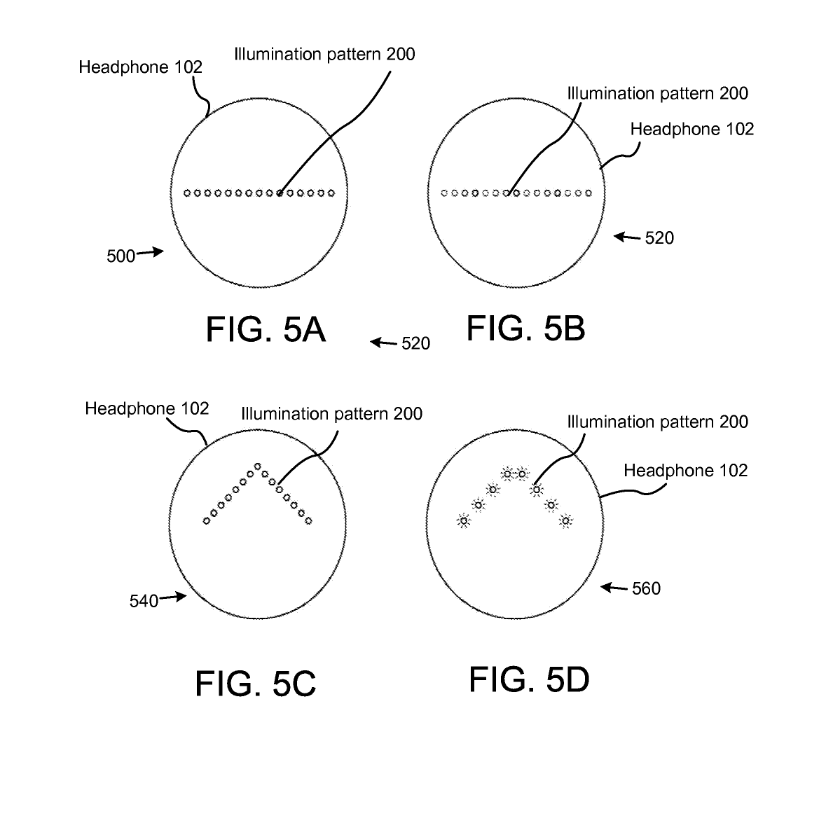

In one embodiment of the present invention, the LEDs 104 are configured to operate as a function of a volume and a rhythm of the audio signal, wherein the intensity and frequency of the LEDs 104 is variable. The LEDs 104 may also vary in conjunction with intensity and a frequency of the audio signal. In this manner, the state of the audio signal is visually indicated with flashing LEDs 104. For example, without limitation, the LEDs 104 may flash in accordance with a musical beat of the audio signal. In some embodiments, the configuration and shape of the LEDs 104 on the at least one headphone 102 forms an illumination pattern 200. The illumination pattern 200 may form, in essence, a volume meter that is visible from an external surface of the at least one headphone 102 (FIG. 4). The illumination pattern 200 may include various shapes and configurations, including, without limitation, a series of dashed lines, semi-circular, straight line, V-shaped, chevron, square, pyramid, diagonal line, text, and a graphical depiction, as referenced in FIG. 5. In yet another embodiment, a secondary illumination pattern 200 may display on the at least one headphone 102 to indicate a bass and a treble of the audio signal.

In one embodiment of the present invention, a controller 202 regulates the audio signal, and other related functions of the system 100. The controller 202 may operate remotely. In some embodiments, a USB cable 204 is configured to transmit signals and/or power to the system 100. In this manner, the system 100 may join with portable electronic devices, including, without limitation, cellular telephones, personal digital assistants, portable music players, and computers. A battery 206 may provide an internal source of power for powering the audio and illumination components of the system 100.

In various embodiments, the headphones each contain an internal power source, such as a removable or fixed battery. In various other embodiments, the headphones are powered by power relayed via USB cable. In these embodiments, the headphones may be interchangeable with a personal computer, laptop, or other data-processing device (DPD). In various embodiments, a portable music playing apparatus, such as an iPhone® or smart phone is adopted to interface via USB with the headphones.

In some embodiments, the LEDs 104 generate a considerable amount of heat within the at least one headphone 102. A heat sink positioned within the at least one headphone 102 may be efficacious for dissipating the heat generated by the LEDs 104.

In one alternative embodiment, a headphone band that contours the head may illuminate in conjunction with the at least one headphone. In yet another alternative embodiment, the illumination may comprise an incandescent light source. In yet another alternative embodiment, an audio device in the at least one headphone 102 emits audio signals that synchronize with the illumination pattern 200.

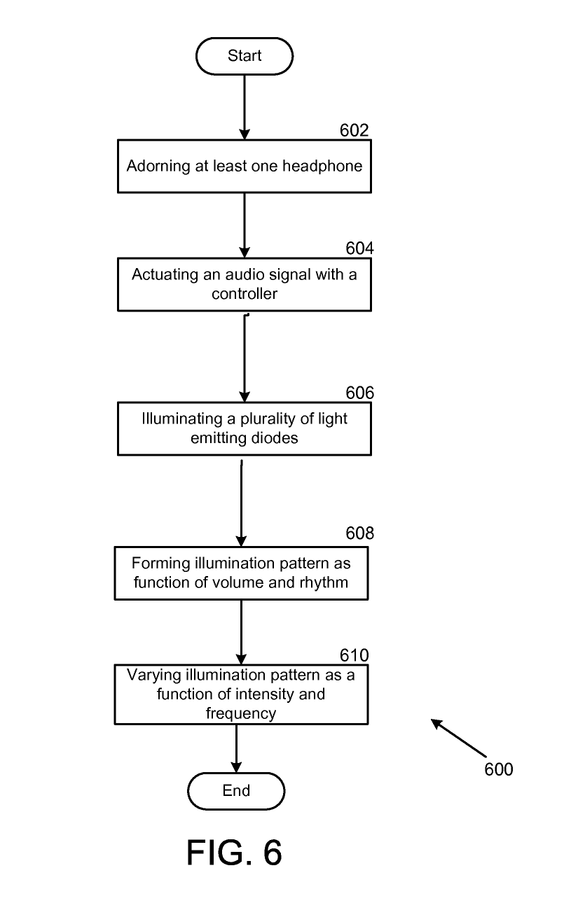

In FIG. 6, a method 600 for illuminating a headphone 102 with the LEDs 104 as a function of volume and rhythm to indicate the status of the audio signal emitting form the at least one headphone 102 is described. The method 600 in the disclosed embodiments substantially includes the steps necessary to carry out the functions presented above with respect to the operation of the described system 100.

The method 600 may include an initial Step 602 of adorning the at least one headphone 102. The at least one headphone 102 is configured to be operable to position on the head, whereby onlookers may observe the status of the audio signal that display in the at least one headphone 102. The at least one headphone 102 may include, without limitation, ear buds, a headset, and an in-ear monitor.

In some embodiments, a next Step 604 includes actuating the audio signal with a controller 202. The controller 202 may control various functions, including, without limitation, power, volume, balance, bass, and treble. The controller 202 may also regulate the intensity of the illumination. In some embodiments, the controller may control numerous functions, including, without limitation, power, volume, bass, treble, and illumination intensity. A volume meter may display to indicate the volume and rhythm of the audio signal.

A next Step 606 may include illuminating the LEDs 104. Those skilled in the art, in light of the present teachings, will recognize that the LEDs 104 utilize electroluminescence to generate light. When LEDs 104 power on, electrons recombine with holes within the LEDs 104, releasing energy in the form of photons. This effect is called electroluminescence and the color of the light, corresponding to the energy of the photon, is determined by the energy band gap of the semiconductor.

The method 600 may then proceed to a Step 608 of forming an illumination pattern 200 as a function of a volume and a rhythm of the audio signal. The illumination pattern 200 may comprise predetermined spaces where the LEDs 104 position. The synchronization of the LEDs 104 in the predetermined spaces forms a volume meter.

A final Step 610 includes varying the illumination pattern 200 as a function of an intensity and frequency of the audio signal. The intensity and frequency of the audio signal may also dictate the illumination pattern 200. The type of audio signal may be indicated in this manner. For example, music my comprise short, blinking illumination, while a talk show may display longer durations of illumination.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A headphone for providing illumination as a function of a volume and a rhythm of an audio signal, the headphone comprising:
at least one headphone, the at least one headphone being configured to engage an ear of a wearer and emit an audio signal;
a plurality of light emitting diodes (LEDs), wherein each of the plurality of LEDs is detachably affixed to the headphone in a recess defined by a housing forming the headphone,;
wherein the plurality of LEDs form an illumination pattern, the illumination pattern being configured to illuminate as a function of the volume and the rhythm of the audio signal, the illumination pattern further being configured to vary in conjunction with an intensity and a frequency of the audio signal; and
a controller, the controller being operable to control the audio signal.

2. The headphone of claim 1, wherein the plurality of LEDs are operable as a function of the strength and power of the audio signal.

3. The headphone of claim 1, wherein the plurality of LEDs are disposed to position on an outer surface of the at least one headphone, wherein the illumination pattern is visible externally through an overlaying, transparent, polymeric shell.

4. The headphone of claim 1, wherein the at least one headphone comprises a plurality of predetermined recesses for receiving the plurality of LEDs.

5. The headphone of claim 1, wherein the at least one headphone comprises a square grid for receiving the plurality of light emitting diodes, wherein each LED in the square grid illuminates independently as a function of the audio signal to generate a variable pattern of illumination.

6. The headphone of claim 1, further comprising an ambient light sensor, wherein a brightness of the plurality of LEDs decreases in a dark environment.

7. The headphone of claim 1, further comprising a battery for powering the headphone system.

8. The headphone of claim 1, further comprising a USB cable, the USB cable being configured to transmit a signal and power to the headphone.

9. The headphone of claim 1, further including a heat sink for dissipating heat from the plurality of LEDs.

10. The headphone of claim 1, wherein the illumination pattern visible on the headphones forms of the following shapes, a chevron, a wave, and a triangle.

11. A method for illuminating a plurality of light emitting diodes (LEDs) as a function of a volume and a rhythm of an audio signal, the method comprising:
adorning at least one headphone with LEDs visible through a convex polymeric shell;
amplifying an audio signal with a controller;
illuminating a plurality of LEDs in response to the audio signal exceeding a predetermined decibel level;
forming an LED illumination pattern as a function of a volume and a rhythm of the audio signal; and
varying the illumination pattern as a function of an intensity and frequency of the audio signal.
